(19) United States
(12) Patent Application Publication
(10) Pub. No.: US 2014/0205990 A1
(43) Pub. Date: Jul. 24, 2014

(54) Machine Learning for Student Engagement

(71) Applicant: CLOUDVU, INC., Sandy, UT (US)

(72) Inventors: Richard W. Wellman, Park City, UT (US); Kelly D. Phillipps, Salt Lake City, UT (US); David B. Gonzalez, Provo, UT (US)

(73) Assignee: CloudVu, Inc., Sandy, UT (US)

(21) Appl. No.: 13/749,618

(22) Filed: Jan. 24, 2013

(51) Int. Cl. G09B 7/00

(52) U.S. Cl. CPC G09B 7/00
USPC 434/362

(57) ABSTRACT

Apparatuses, systems, methods, and computer program products are disclosed for determining student engagement. A method includes receiving data collected from interactions of a plurality of students with an electronic learning system. A method includes identifying a plurality of archetypal learning patterns in received data using machine learning. A method may also include associating a student with at least one identified archetypal learning patterns using machine learning.

### TECHNICAL FIELD

The present disclosure, in various embodiments, relates to electronic learning systems and more particularly relates to using machine learning to identify patterns in student engagement relative to electronic learning systems.

### BACKGROUND

Academic institutions and other learning entities increasingly provide electronic learning materials, either to replace or to supplement traditional, classroom pedagogical methods. While electronic learning materials are often convenient, effective, and efficient, their use can limit personal interactions between teachers and students. This lack of personal contact can make it difficult for academic institutions to determine whether students using electronic learning materials are engaged by the material, whether students are likely to succeed academically, or the like.

### SUMMARY

From the foregoing discussion, it should be apparent that a need exists for an apparatus, system, method, and computer program product for determining student engagement. Beneficially, such an apparatus, system, method, and computer program product would use machine learning to identify patterns in student engagement relative to an electronic learning system.

The present disclosure has been developed in response to the present state of the art, and in particular, in response to the problems and needs in the art that have not yet been fully solved by currently available electronic learning systems. Accordingly, the present disclosure has been developed to provide an apparatus, system, method, and computer program product for determining student engagement that overcome many or all of the above-discussed shortcomings in the art.

Methods are presented for determining student engagement. A method, in one embodiment, includes receiving data collected from interactions of a plurality of students with an electronic learning system. In a further embodiment, a method includes identifying a plurality of archetypal learning patterns in received data using machine learning. A method, in another embodiment, includes associating a student with at least one identified archetypal learning pattern using machine learning.

A method, in one embodiment, includes modeling a student as a time series path through one or more lessons of an electronic learning system. Associating each student with at least one identified archetypal learning pattern, in certain embodiments, comprises correlating a time series path for a particular student with the associated at least one identified archetypal learning pattern. In a further embodiment, a method includes sending an alert for at least one student based on at least one archetypal learning pattern associated with the at least one student.

In certain embodiments, received data comprises substantially all data generated by interactions of a plurality of students with an electronic learning system. A plurality of archetypal learning patterns, in one embodiment, is based at least partially on known learning outcomes for a set of students.

Received data, in one embodiment, comprises monitored mouse movement of a student using an electronic learning system. In another embodiment, received data comprises an amount of time a student remains on a presented page of an electronic learning system. In a further embodiment, received data comprises text selected by a student from material of an electronic learning system.

In one embodiment, a plurality of archetypal learning patterns comprises one or more macro archetypal learning patterns associated with a student's overall success relative to an electronic learning system. In a further embodiment, a plurality of archetypal learning patterns comprises one or more course archetypal learning patterns associated with a single instructional course of an electronic learning system. In another embodiment, a plurality of archetypal learning patterns comprises one or more micro archetypal learning patterns associated with a particular lesson of an electronic learning system.

Machine learning, in certain embodiments, includes a machine learning ensemble comprising a plurality of learned functions from multiple classes. A plurality of learned functions of a machine learning ensemble, in one embodiment, are selected from a larger plurality of generated learned functions.

Received data, in one embodiment, is collected using a browser extension installed in internet browsers for each of a plurality of students. In another embodiment, received data is collected using a proxy server disposed between a plurality of students and an electronic learning system. Received data, in a further embodiment, is collected using executable code embedded in pages sent to a plurality of students by an electronic learning system.

Apparatuses for determining student engagement are presented. In one embodiment, an activity monitor module is configured to receive monitored electronic learning interactions of one or more students. A machine learning module, in a further embodiment, is configured to compare, using machine learning, monitored electronic learning interactions to a plurality of archetypal learning patterns. In another embodiment, a result module is configured to send an alert for at least one student based on a machine learning comparison.

A result module, in certain embodiments, is configured to send an alert to an authority associated with at least one student. An alert, in one embodiment, recommends a learning action to take with regard to at least one student. A machine learning module, in a further embodiment, is configured to determine a recommended learning action using machine learning. A result module, in another embodiment, is configured to send an alert to at least one student. In one embodiment, an alert recommends a learning action for a student to take. An alert, in certain embodiments, comprises a real-time notification presented to at least one student during electronic learning interactions of the at least one student.

An ensemble factory module, in one embodiment, is configured to form machine learning comprising a machine learning ensemble. A machine learning ensemble, in another embodiment, comprises a plurality of learned functions from multiple classes. An ensemble factory module, in certain embodiments, is configured to generate a larger plurality of generated learned functions using training data and to select a plurality of learned functions for a machine learning ensemble based on an evaluation of the larger plurality of learned functions using test data.

An ensemble factory module, in one embodiment, is configured to combine multiple learned functions from a larger plurality of generated learned functions to form a combined learned function for a machine learning ensemble. In a further embodiment, an ensemble factory module is configured to add one or more layers to at least a portion of a larger plurality of generated learned functions to form one or more extended learned functions for a machine learning ensemble. Machine learning, in certain embodiments, comprises a plurality of different machine learning ensembles associated with different archetypal learning patterns.

Monitored electronic learning interactions, in one embodiment, include monitored mouse movement of one or more students. In another embodiment, monitored electronic learning interactions include an amount of time one or more students remain on a presented electronic learning page. Monitored electronic learning interactions, in a further embodiment, include text selected by one or more students from electronic learning material.

In one embodiment, an activity module is configured to receive monitored electronic learning interactions from a browser extension installed in internet browsers for one or more students. An activity module, in a further embodiment, is configured to receive monitored electronic learning interactions from a proxy server disposed between one or more students and an electronic learning system providing the electronic learning interactions. An activity module, in another embodiment, is configured to receive monitored electronic learning interactions from executable code embedded in pages with which one or more students are interacting.

A plurality of archetypal learning patterns, in one embodiment, includes a macro archetypal learning pattern associated with an overall result of a student's electronic learning interactions. In another embodiment, a plurality of archetypal learning patterns includes a course archetypal learning pattern associated with a single electronic course. In a further embodiment, a plurality of archetypal learning patterns includes a micro archetypal learning pattern associated with a particular electronic lesson.

Computer program products are presented. In one embodiment, a computer program product comprises a computer readable storage medium storing computer usable program code executable to perform operations for determining student engagement. An operation, in one embodiment, includes receiving data associated with interaction of a plurality of students with electronic learning material. In another embodiment, an operation includes comparing, using machine learning, monitored interaction with a plurality of archetypal learning patterns. In a further embodiment, an operation includes evaluating electronic learning material based on a machine learning comparison. In certain embodiments, an operation includes recommending a modification to electronic learning material based on a machine learning comparison

Systems for determining student engagement are presented. In one embodiment, a student engagement module is configured to be in communication with a plurality of students, one or more electronic learning publishers, and/or one or more learning institutions. A student engagement module, in certain embodiments, includes an activity monitor module configured to monitor electronic learning interactions of a plurality of students with electronic learning material from one or more electronic learning publishers. In another embodiment, a student engagement module includes a machine learning module configured to associate a student with a determined learning archetype, using machine learning, based on monitored electronic learning interactions and on publisher data from one or more electronic learning publishers.

A student engagement module, in another embodiment, includes a result module configured to send an alert to one or more learning institutions. An alert, in one embodiment, recommends a learning action to take with regard to one or more students. A machine learning module, in certain embodiments, is configured to determine a recommended learning action using machine learning.

A result module, in one embodiment, is configured to send an alert to one or more students. In certain embodiments, an alert recommends a learning action for one or more students to take. In a further embodiment, a result module is configured to send an evaluation of electronic learning material to one or more electronic learning publishers. A machine learning module, in one embodiment, is configured to determine an evaluation of electronic learning material using machine learning.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. The disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1A is a schematic block diagram illustrating one embodiment of a system for determining student engagement;

FIG. 1B is a schematic block diagram illustrating one embodiment of a system for determining student engagement;

FIG. 1C is a schematic block diagram illustrating one embodiment of a system for determining student engagement;

FIG. 2A is a schematic block diagram illustrating one embodiment of a student engagement module;

FIG. 2B is a schematic block diagram illustrating another embodiment of a student engagement module;

FIG. 3 is a schematic block diagram illustrating one embodiment of an ensemble factory module;

FIG. 4 is a schematic block diagram illustrating one embodiment of a system for an ensemble factory;

FIG. 5 is a schematic block diagram illustrating one embodiment of learned functions for a machine learning ensemble;

FIG. 6 is a schematic flow chart diagram illustrating one embodiment of a method for an ensemble factory;

FIG. 7 is a schematic flow chart diagram illustrating another embodiment of a method for an ensemble factory;

FIG. 8 is a schematic flow chart diagram illustrating one embodiment of a method for directing data through a machine learning ensemble;

FIG. 9 is a schematic flow chart diagram illustrating one embodiment of a method for determining student engagement;

FIG. 10 is a schematic flow chart diagram illustrating one embodiment of a method for determining student engagement;

FIG. 11 is a schematic flow chart diagram illustrating one embodiment of a method for determining student engagement; and

FIG. 12 is a schematic flow chart diagram illustrating one embodiment of a method for determining student engagement.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

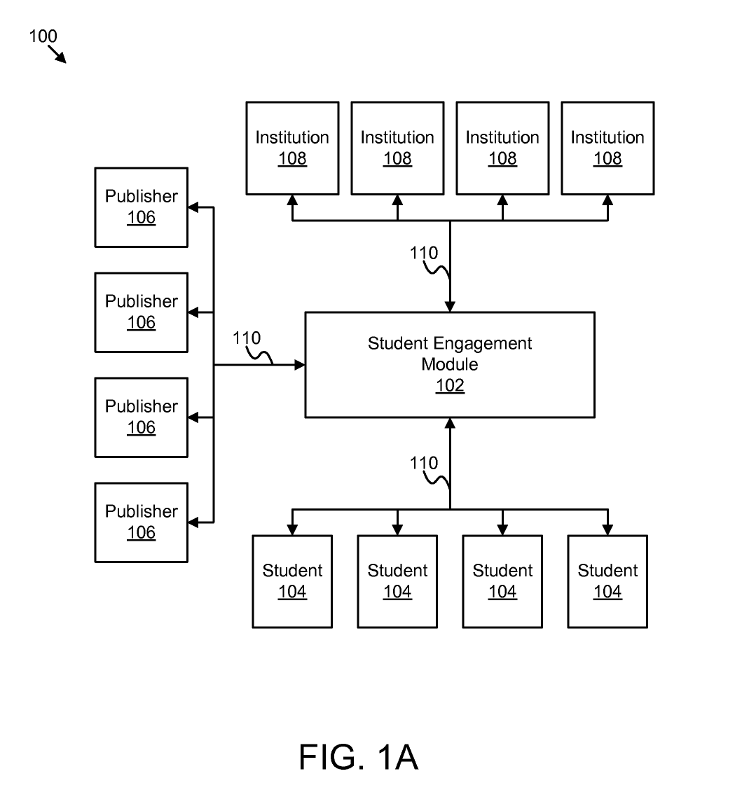

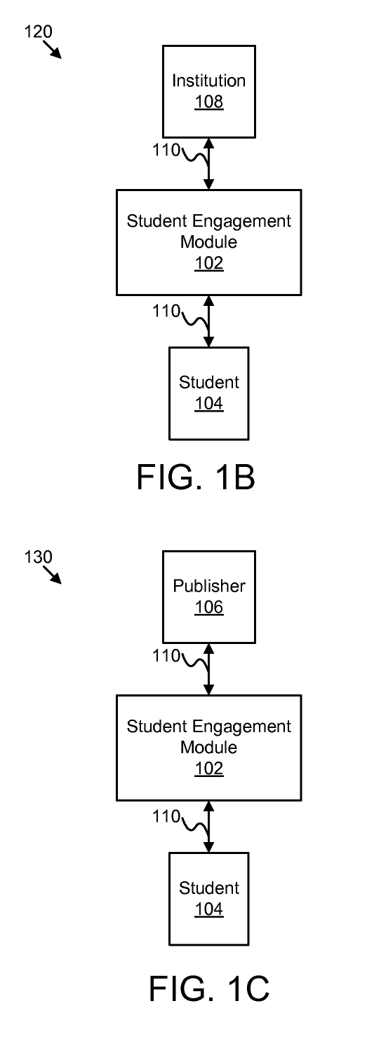

FIG. 1A depicts one embodiment of a system 100 for determining student engagement. The system 100, in the depicted embodiment, includes a student engagement module 102 configured to determine student engagement and/or dis-engagement using machine learning. The student engagement module 102, in the depicted embodiment, may be in communication with one or more students 104, one or more electronic learning publishers 106, one or more learning institutions 108, or the like to determine engagement of the students 104 with regard to electronic learning material provided by the electronic learning publishers 106 and/or the learning institutions 108 to the students 104.

The student engagement module 102 may comprise computer executable code and/or logic hardware. For example, the student engagement module may comprise computer executable code executing on a server or other computing device of the electronic learning publishers 106 and/or the learning institutions 108, executing on a client device or other computing device of the students 104, or the like. A learning institution 108, in various embodiments, may comprise an academic institution such as a university, college, secondary school, primary school, technical school, or the like for teaching students 104; a business entity that trains or teaches employees 104; a charitable or non-profit entity that provides instructional training courses; and/or another entity that teaches or trains individuals 104. The one or more learning institutions 108 provide electronic learning material to students 104 such as lessons, courses, assignments, tests, quizzes, or the like using an electronic learning system comprising one or more computing devices or servers. In one embodiment, the electronic learning material for the one or more learning institutions 108 is provided by one or more electronic learning publishers 106, as one or more webpages, computer applications, or other interactive electronic format. For example, a learning institution 108 may contract with one or more electronic learning publishers 106 to provide electronic learning material, may purchase electronic learning material from one or more electronic learning publishers 106, may form one or more electronic learning publishers 106 as a division or department, or the like.

The student engagement module 102, in various embodiments, may be integrated with, co-located with, or otherwise in communication with one or more computing devices of a student 104, an electronic learning publisher 106, a learning institution 108, and/or another computing device. For example, the student engagement module 102 may execute on the same host computing device as an electronic learning system server of a learning institution 108 and/or an electronic learning publisher 106, and may communicate with the electronic learning system server using an API, a function call, a hardware bus or other command interface, or using another local channel. In another embodiment, the student engagement module 102 may be in communication with the students 104, the electronic learning publishers 106, and/or the learning institutions 108 over the data network 110, such as a local area network (LAN), a wide area network (WAN) such as the Internet, a wireless network, a wired network, or another data network 110.

In one embodiment, the student engagement module 102 may be installed on, integrated with, co-located with, or otherwise in communication with a proxy server or other computing device disposed as an intermediary between the students 104 and the electronic learning publishers 106 and/or the learning institutions 108, filtering or processing communications on a data network 110. In a further embodiment, the student engagement module 102 may include computer executable code installed as a browser extension, plug-in, or add-on for internet browsers of the students 104. The student engagement module 102, in another embodiment, includes computer executable code embedded in webpages or other electronic learning material, using a client-side scripting language such as JavaScript, Perl, or the like. Using a proxy server, a browser extension, and/or embedded code, the student engagement module 102, in certain embodiments, monitors, directly or indirectly, interactions between the students 104 and electronic learning material of an electronic learning system 100 provided by the electronic learning publishers 106 and/or the learning institutions 108.

The student engagement module 102, in one embodiment, may use machine learning, such as one or more machine learning ensembles or other learned functions, to determine one or more archetypal learning patterns, to associate or correlate students 104 with an archetypal learning pattern, or the like. As used herein, an archetypal learning pattern for a student 104 comprises a representation of habits and/or interactions of a plurality of students 104 having a similar level or tier of learning outcomes (e.g., scores, grades, or the like). The student engagement module 102 may use machine learning to recommend or prescribe a learning action to a student 104, to an authority at a learning institution 108, or the like.

In a further embodiment, the student engagement module 102 may evaluate learning material from the electronic learning publishers 106 and/or the learning institutions 108, using machine learning. For example, the student engagement module 102 may use machine learning to determine one or more archetypal learning (or teaching) patterns for electronic learning material, and/or for a teacher, professor, or other authority, may associate electronic learning material and/or an authority with a determined archetypal learning pattern, and evaluate the electronic learning material and/or authority based on the associated archetypal learning and/or teaching pattern. While determining student engagement is primarily described herein, in other embodiments, the description may be equally applicable to evaluating electronic learning material and/or authorities such as teachers or professors, as described in greater detail below.

In one embodiment, instead of simply processing a student's interaction with online or electronic learning material using action-oriented activities (e.g., button clicks, menu clicks) and/or content-oriented activities (e.g., page load, links followed), the student engagement module 102 monitors or collects a student's behavior oriented activities (e.g., mouse movement and/or periods of inactivity, browser tab focus/un-focus, browser window focus/un-focus, browser type/user agent, hovering cursor over page elements, key click events, scroll events, time on a page, text highlighting or selection, time on task, clicks on page elements), to gauge or determine student engagement relative to electronic learning material of an electronic learning system 100 provided by the electronic learning publishers 106 and/or the learning institutions 108.

The student engagement module 102, in certain embodiments, may determine one or more archetypal learning patterns for students 104 based on monitored or collected interactions, known learning outcomes (e.g., grades, test scores) for the students 104, or the like. The student engagement module 102, in one embodiment, may compare monitored or collected student interaction data to the archetypal learning patterns to determine a student engagement, likelihood of success, recommend a learning action, evaluate electronic learning material, or the like using machine learning. In this manner, the student engagement module 102, in certain embodiments, may increase a student 104's engagement with electronic learning materials, increase a student 105's understanding of the information conveyed in electronic learning materials, or the like. Identifying patterns of student engagement using machine learning, in one embodiment, may utilize experimentation, monitoring, and/or analyzing of large amounts of collected data, inferring engagement from how well a student 104 performs on an assessment, or the like.

FIG. 1B depicts one embodiment of a system 120 for determining student engagement. The student engagement module 102 of FIG. 1B, in certain embodiments, may be substantially similar to the student engagement module 102 described above with regard to FIG. 1A. In the depicted embodiment, the student engagement module 102 is disposed between one or more learning institutions 108 and one or more students 104 as an intermediary (e.g., including a browser extension, proxy server, embedded code, or the like), to monitor, collect, or otherwise receive student interaction data with an electronic or online learning system provided by the one or more learning institutions 108. The student engagement module 102, in various embodiments, may use machine learning to provide alerts to the one or more learning institutions 108 and/or the one or more students 104.

FIG. 1C depicts one embodiment of a system 130 for determining student engagement. The student engagement module 102 of FIG. 1C, in certain embodiments, may be substantially similar to the student engagement module 102 described above with regard to FIG. 1A and/or FIG. 1B. In the depicted embodiment, the student engagement module 102 is disposed between one or more electronic learning publishers 106 and one or more students 104 as an intermediary (e.g., including a browser extension, proxy server, embedded code, or the like), to monitor, collect, or otherwise receive student interaction data with an electronic or online learning system provided by the one or more electronic learning publishers 106. The student engagement module 102 may use machine learning to evaluate electronic or online learning material provided by the electronic learning publisher 106, to provide alerts to the one or more students 104, or the like.

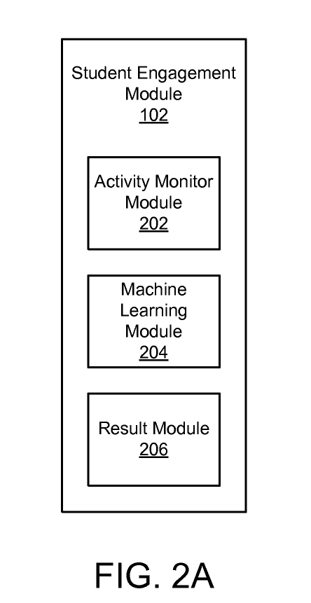

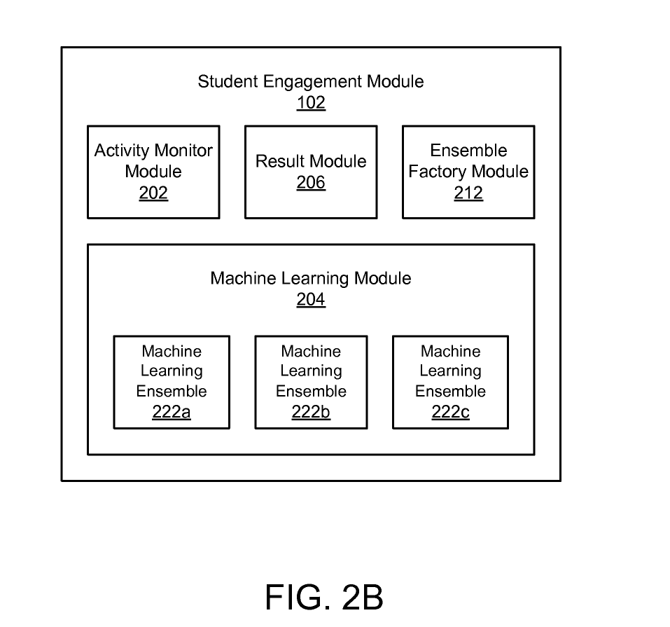

FIG. 2A depicts one embodiment of a student engagement module 102. The student engagement module 102 of FIG. 2A, in certain embodiments, may be substantially similar to the student engagement module 102 described above with regard to FIGS. 1A-1C. In the depicted embodiment, the student engagement module 102 includes an activity monitor module 202, a machine learning module 204, and a result module 206.

In one embodiment, the activity monitor module 202 is configured to monitor, collect, or otherwise receive data associated with electronic learning interactions of a plurality of students 104 with electronic learning material of an electronic learning system. The activity monitor module 202, in certain embodiments, may monitor electronic learning interactions itself, directly, including a browser extension installed in an internet browser of one or more students 104, a proxy server, computer executable code embedded in a webpage or other learning material, or the like. In another embodiment, the activity monitor module 202 may indirectly monitor electronic learning interactions, receiving data associated with the electronic learning interactions from an external entity, such as a browser extension installed in an internet browser of one or more students 104, a proxy server, computer executable code embedded in a webpage or other learning material, one or more electronic learning publishers 106, one or more learning institutions 108, or the like in communication with the activity monitor module 202.

Data associated with electronic learning interactions, in various embodiments, may include data input by a student 104 or other user using a user input device (e.g., a mouse, keyboard, touchpad, touchscreen, microphone, camera, or the like), a movement or action of a student 104 or other user, a detected characteristic of a student 104 or other user, or other collectible data, such as mouse movement and/or periods of inactivity, browser tab focus/un-focus, browser window focus/un-focus, browser type/user agent, hovering cursor over page elements, key click events, scroll events, time on a page, text highlighting or selection, time on task, clicks on page elements, or the like. In one embodiment, the activity monitor module 202 monitors or otherwise receives mouse or other cursor movement of one or more students 104 as the students 104 use and interact with an electronic learning system. In a further embodiment, the activity monitor module 202 monitors or otherwise receives data representing an amount of time one or more students 104 remain on a presented page, lesson, or other learning material of an electronic learning system. In another embodiment, the activity monitor module 202 monitors or otherwise receives data indicating or associated with text selected or highlighted by one or more students 104 from learning material of an electronic learning system.

In another embodiment, the data associated with electronic learning interactions that the activity monitor module 202 monitors or otherwise receives may include one or more indirect or supplemental indicators of a student 104's engagement, or conversely dis-engagement, with electronic learning material. For example, in certain embodiments, the activity monitor module 202 may monitor or otherwise receive data indicating other webpages and/or applications that are open on a student 104's computing device during an electronic learning session with an electronic learning system, data from a microphone or the like indicating ambient noise or other activities occurring around a student during an electronic learning session with an electronic learning system, or other data that may not be strictly academic, but may indicate distraction, boredom, frustration, or the like of a student 104 relative to the electronic learning material.

In certain embodiments, the activity monitor module 202 monitors or otherwise receives substantially all data generated by interactions of one or more students 104 with an electronic learning system. The activity monitor module 202, in a further embodiment, may monitor or otherwise receive electronic learning interactions associated with multiple students 104, multiple electronic learning publishers 106, and/or multiple learning institutions 108. The accuracy and/or effectiveness of machine learning predictions, recommendations, or the like, in certain embodiments, may increase as an amount of data monitored and/or received by the activity monitor module 202 increases.

In one embodiment, the machine learning module 204 is configured to compare, using machine learning, the monitored or otherwise received electronic learning interactions from the activity monitor module 202 to a plurality of archetypal learning patterns. The machine learning module 204, in certain embodiments, determines the archetypal learning patterns using machine learning. In further embodiments, the archetypal learning patterns may be predefined.

As described above, an archetypal learning pattern for students may comprise a representation of habits and/or interactions of a plurality of students having a similar level or tier of learning outcomes (e.g., scores, grades, or the like), such as previously monitored students 104, previous academic periods (e.g., semester, trimester, quarter), different courses, different electronic learning publishers 106, different learning institutions 108, or the like. An archetypal learning or teaching pattern for an authority such as a teacher or professor may comprise a representation of habits, interactions, and/or teaching methods grouped by effectiveness at teaching and/or engaging students 104, or the like. Similarly, an archetypal learning or teaching pattern for electronic learning material (e.g., an electronic lesson, an electronic assignment, an electronic test or quiz) may comprise a representation of electronic learning material or components thereof, grouped by effectiveness at teaching and/or engaging students 104, or the like.

The machine learning module 204, in one embodiment, bases an archetypal learning pattern at least partially on known learning outcomes for a set of one or more students (e.g., a grade, a score, pass/fail, graduated/dropped-out, changed major/minor, progress within a course, progress within a major, progress within a learning module, efficiency moving through learning material, matriculation, or the like). An archetypal learning pattern, in one embodiment, may comprise a macro archetypal learning pattern, associated with a student 104's overall success relative to an electronic learning system and/or learning institution 108 over time (e.g., whether a student 104 is admitted, whether a student 104 graduates, a student 104's major/minor, grade point average (GPA), or the like). In a further embodiment, an archetypal learning pattern may comprise a course archetypal learning pattern associated with a single instructional course of the electronic learning system (e.g., a grade for the course, an amount of time to complete the course, pass/fail for a course, scores for course assignments, or the like). In another embodiment, an archetypal learning pattern may comprise a micro archetypal learning pattern associated with a particular lesson of an electronic learning system (e.g., time on a page of the lesson, a score for an assignment or quiz of the lesson, mouse or cursor movement during the lesson, text selected or highlighted during the lesson, page scrolling during a lesson, graphical elements selected or clicked on during a lesson, external material referenced or accessed during a lesson, or the like).

In certain embodiments, the machine learning module 204 may use different machine learning, such as a different machine learning ensemble or learned function, for each different archetypal learning pattern, or the like. The machine learning module 204 may form a machine learning ensemble using the ensemble factory module 212 described below with regard to FIG. 2B. For example, the machine learning module 204 may cooperate with the ensemble factory module 212 to form or generate a machine learning ensemble for a plurality of different archetypal learning patterns using training data and/or test data such as previously monitored students 104, previous academic periods (e.g., semester, trimester, quarter), different courses, different electronic learning publishers 106, different learning institutions 108, or the like.

The machine learning module 204, in one embodiment, may input monitored and/or received data from the activity monitor module 202 into machine learning, such as one or more machine learning ensembles, to associate a particular student with an archetypal learning pattern. For example, the machine learning module 204 may input monitored and/or received data for a particular student into each of a plurality of different machine learning ensembles to compare electronic learning interactions to the archetypal learning patterns, and select the archetypal learning pattern associated with the machine learning ensemble that outputs the highest confidence metric to associate with the particular student.

The machine learning module 204, may be configured to use supplemental data, such as publisher data from one or more electronic learning publishers 106 (e.g., an answer key to an electronic test, quiz, or assignment; a student 104's scores; historical data; enrollment data; resource data; interactive data; or the like), academic or learning data from one or more learning institutions 108 (e.g., extracurricular data, admissions data, attendance data, grades or scores from other courses, academic records, records of interactions with an instructor or other authority, effectiveness of a previous alert or recommendation from the result module 206, or the like), and/or other supplemental data to determine one or more archetypal learning patterns, to associate a student 104 with an archetypal learning pattern, to determine an alert, to evaluate electronic learning material, or the like. In certain embodiments, an electronic learning publisher 106 may collect similar or complimentary data to data monitored or otherwise received by the activity monitor module 202, for previous students 104, or the like, such as mouse movement, scroll events, time on a page, text highlighting or selection, time on task, clicks on page elements, scores, grades, or the like. The machine learning module 204, in one embodiment, may use data from one or more electronic learning publishers 106 (e.g., historical data, data for other students 104) in cooperation with the ensemble factory module 212 or the like, as training data and/or test data to generate machine learning, such as one or more machine learning ensembles or the like.

To facilitate comparing and/or correlating electronic learning interactions of a student 104 to a plurality of archetypal learning patterns, in one embodiment, in one embodiment, the machine learning module 204 is configured to model each student as a time series path through one or more lessons of an electronic learning system. In a further embodiment, the machine learning module 204 may model an archetypal learning pattern as a time series path through one or more lessons of an electronic learning system. To associate a particular student with an archetypal learning pattern, in one embodiment, the machine learning module 204 correlating a time series path for the particular student with the an archetypal learning pattern (e.g., a nearest archetypal learning pattern, a most similar archetypal learning pattern, or the like).

In certain embodiments, the machine learning module 204 may evaluate electronic learning material using machine learning, such as a comparison of electronic learning interactions between a student and the electronic learning material, with archetypal learning patterns. For example, the machine learning module 204 may evaluate an electronic lesson, assignment, quiz, test, or other electronic learning material based on a level of student engagement with regard to the material, a comparison with other electronic learning material, or the like. In certain embodiments, the machine learning module 204 may cooperate with the result module 206 to use machine learning to determine an alert, a recommended learning action, an evaluation of electronic learning material, a modification to electronic learning material, or the like.

In one embodiment, the result module 206 is configured to perform an action and/or return a result based on an association, correlation, prediction, result, evaluation, or the like by the machine learning module 204. In certain embodiments, the result module sends an alert to a student 104 and/or an authority of a student 104 based on an association or comparison between a student 104 and an identified archetypal learning pattern by the machine learning module 204. The result module 206, in one embodiment, sends an alert for a student 104 to an authority (e.g., a teacher, professor, advisor, counselor, faculty member, administrator, teaching assistant, parent, relative, interested third party, or the like) associated with the student 104. In a further embodiment, the result module 206 may receive or manage one or more waivers, authorizing the result module 206 to contact an authority such as a parent, relative, third party, or the like, in compliance with information disclosure rules or regulations. The alert may recommend a learning action for the authority to take with regard to the student 104, such as admitting/denying the student 104 admittance, an assignment for the student 104, a different recommended lesson/course/major/minor for the student 104, or the like.

In a further embodiment, the result module 206 sends an alert to a student 104, recommending a learning action for the student 104 to take. For example, the result module 206 may recommend that a student 104 change a study habit, interact differently with the electronic learning material, perform an assignment, change lessons/courses/majors/minors, or the like. As described above, the machine learning module 204 may be configured to determine a recommended learning action for a student 104 and/or an authority, using machine learning or the like. For example, the machine learning module 204, in cooperation with the result module 206 or the like, may determine one or more learning actions which, if taken, may have a substantial likelihood of improving an archetypal learning pattern associated with the student 104.

In one embodiment, the result module 206 may present an alert to a student 104 as a real-time notification during electronic learning interactions of the student with electronic learning material. The machine learning module 204, in certain embodiments, may process data from the activity monitor module 202 substantially in real-time to associate a student and/or electronic learning interactions with one or more archetypal learning patterns, to determine recommended learning actions, or the like. The result module 206 may present a pop-up, sidebar, dropdown, or other real-time notification and/or recommendation to a student 104 during a lesson, assignment, test, or other presentation of electronic learning material. In certain embodiments, a real-time alert or recommended action may allow a student 104 to adjust interaction with an electronic learning system substantially immediately, without waiting for offline analysis, a next lesson, or the like. In other embodiments, the result module 206 may send an alert as an e-mail message, a text message, a voicemail message, an instant message, an internal message within an electronic learning system, or the like.

In certain embodiments, the result module 206 may send an evaluation of electronic learning material to an electronic learning publisher 106 from the machine learning module 204 (e.g., how effective the material is at engaging students or the like). In a further embodiment, the result module 206 may recommend, to an electronic learning publisher 106, a modification to electronic learning material based on a machine learning comparison by the machine learning module 204 or the like.

FIG. 2B depicts another embodiment of a student engagement module 102. In certain embodiments, the student engagement module 102 of FIG. 2B may be substantially similar to the student engagement module 102 described above with regard to FIGS. 1A, 1B, and/or 2A. In the depicted embodiment, the student engagement module 102 includes the activity monitor module 202, the machine learning module 204, and the result module 206 and further includes an ensemble factory module 212.

In one embodiment, the ensemble factory module 212 is configured to form one or more machine learning ensembles 222a-c for the learned function module 204. In certain embodiments, the learned function module 204 may include a plurality of machine learning ensembles 222, for different archetypal learning patterns, students 104, electronic learning publishers 106, learning institutions 108, lessons, courses, majors, or the like.

The ensemble factory module 212, in certain embodiments, generates machine learning ensembles 222a-c with little or no input from a Data Scientist or other expert, by generating a large number of learned functions from multiple different classes, evaluating, combining, and/or extending the learned functions, synthesizing selected learned functions, and organizing the synthesized learned functions into a machine learning ensemble 222. The ensemble factory module 212, in one embodiment, services analysis requests, from the machine learning module 204 or the like, with input from the activity monitor module 202 using the generated one or more machine learning ensembles 222a-c to provide results, recognize patterns, or the like for the result module 206. While the learned function module 204, in the depicted embodiment, includes three machine learning ensembles 222a-c, in other embodiments, the learned function module 204 may include one or more single learned functions not organized into a machine learning ensemble 222; a single machine learning ensemble 222; tens, hundreds, or thousands of machine learning ensembles 222; or the like.

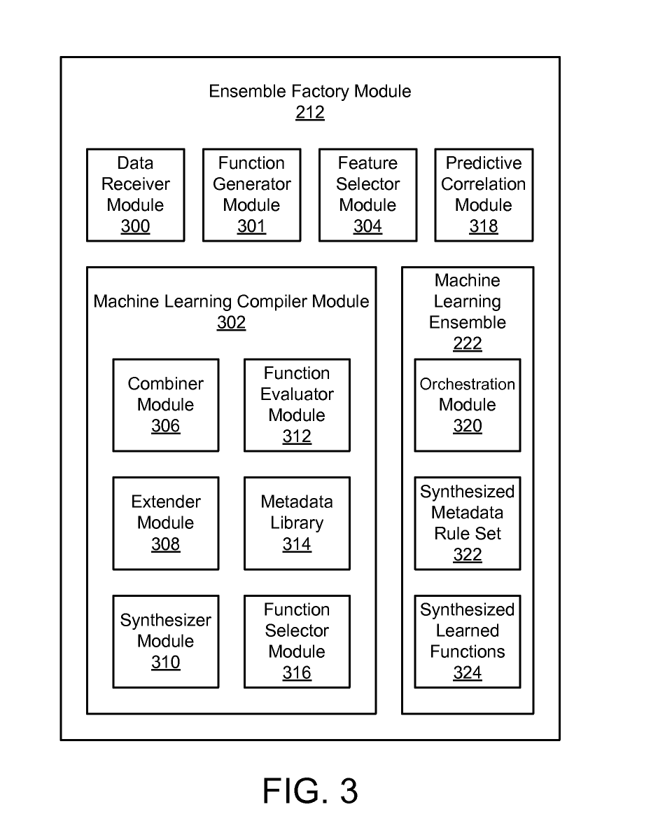

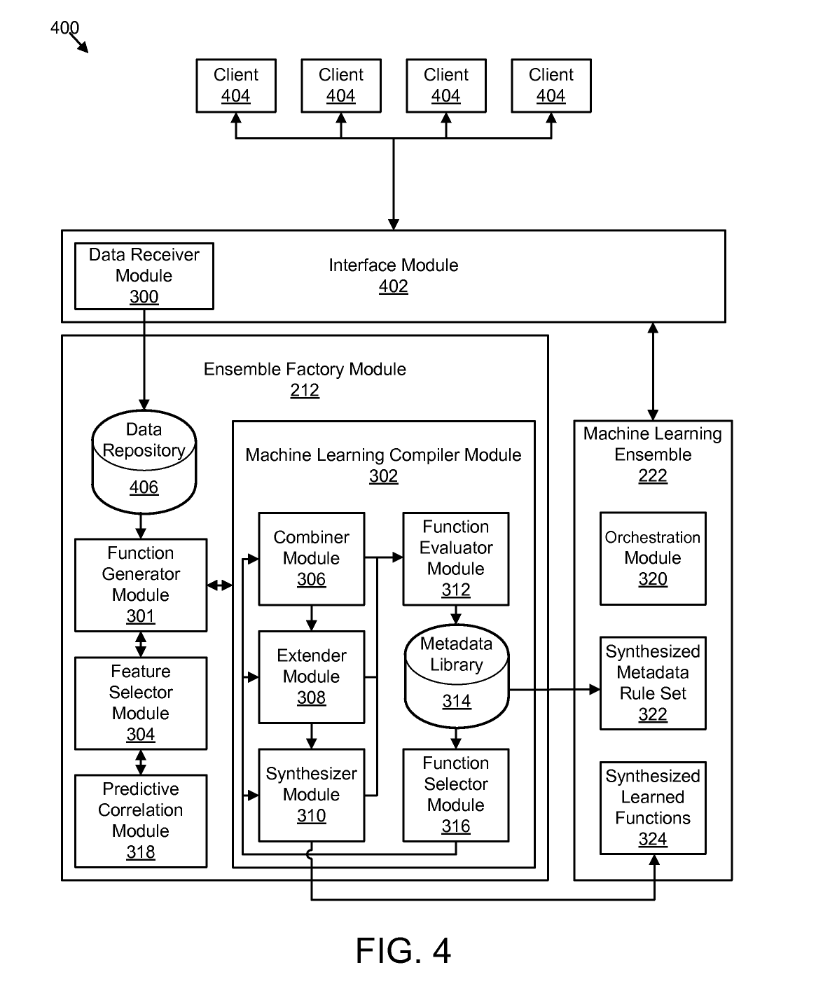

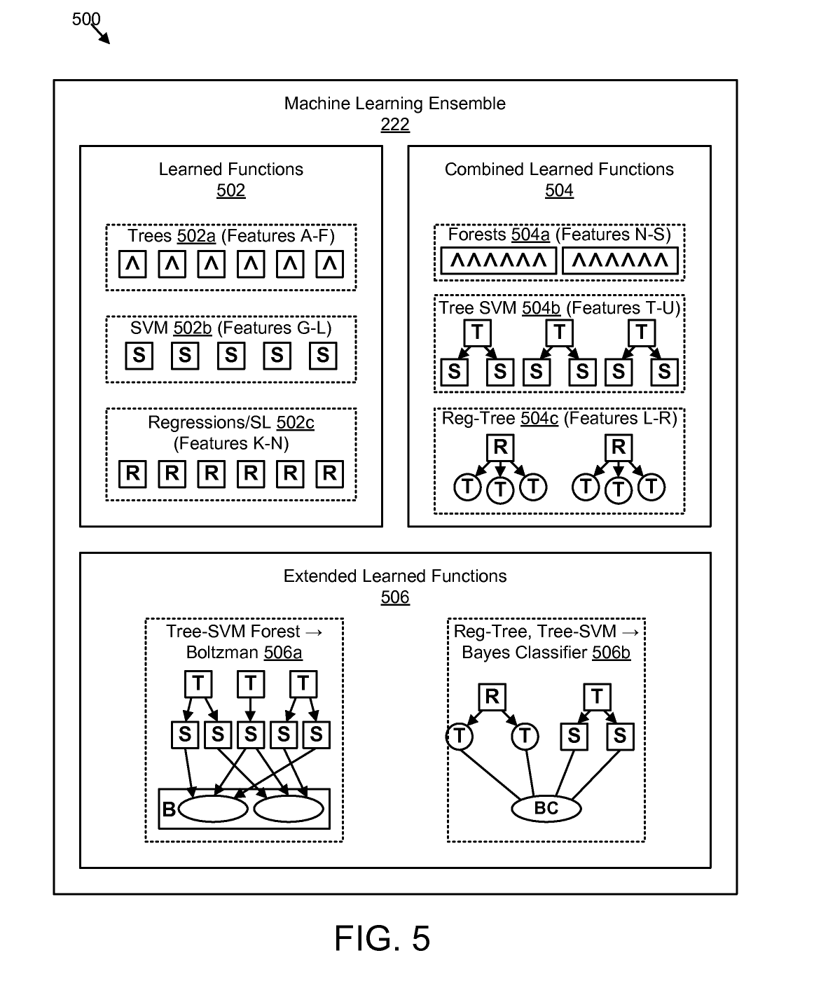

By generating a large number of learned functions, without regard to the effectiveness of the generated learned functions, without prior knowledge of the generated learned functions suitability, or the like, and evaluating the generated learned functions, in certain embodiments, the ensemble factory module 212 may provide machine learning ensembles 222a-c that are customized and finely tuned for a particular machine learning application, without excessive intervention or fine-tuning. The ensemble factory module 212, in a further embodiment, may generate and evaluate a large number of learned functions using parallel computing on multiple processors, such as a massively parallel processing (MPP) system or the like. Machine learning ensembles 222 are described in greater detail below with regard to FIG. 3, FIG. 4, and FIG. 5.

FIG. 3 depicts another embodiment of an ensemble factory module 212. The ensemble factory module 212 of FIG. 3, in certain embodiments, may be substantially similar to the ensemble factory module 212 described above with regard to FIG. 2B. In the depicted embodiment, the ensemble factory module 212 includes a data receiver module 300, a function generator module 301, a machine learning compiler module 302, a feature selector module 304 a predictive correlation module 318, and a machine learning ensemble 222. The machine learning compiler module 302, in the depicted embodiment, includes a combiner module 306, an extender module 308, a synthesizer module 310, a function evaluator module 312, a metadata library 314, and a function selector module 316. The machine learning ensemble 222, in the depicted embodiment, includes an orchestration module 320, a synthesized metadata rule set 322, and synthesized learned functions 324.

The data receiver module 300, in certain embodiments, is configured to receive client data, such as training data, test data, workload data, or the like, from a client 104, either directly or indirectly. The data receiver module 300, in various embodiments, may receive data over a local channel 108 such as an API, a shared library, a hardware command interface, or the like; over a data network 110 such as wired or wireless LAN, WAN, the Internet, a serial connection, a parallel connection, or the like. In certain embodiments, the data receiver module 300 may receive data indirectly from a client 104 through an intermediate module that may pre-process, reformat, or otherwise prepare the data for the ensemble factory module 212. The data receiver module 300 may support structured data, unstructured data, semi-structured data, or the like.

One type of data that the data receiver module 300 may receive, as part of a new ensemble request or the like, is initialization data. The ensemble factory module 212, in certain embodiments, may use initialization data to train and test learned functions from which the ensemble factory module 212 may build a machine learning ensemble 222. Initialization data may comprise historical data, statistics, Big Data, customer data, marketing data, computer system logs, computer application logs, data networking logs, or other data that a client 104 provides to the data receiver module 300 with which to build, initialize, train, and/or test a machine learning ensemble 222.

Another type of data that the data receiver module 300 may receive, as part of an analysis request or the like, is workload data. The ensemble factory module 212, in certain embodiments, may process workload data using a machine learning ensemble 222 to obtain a result, such as a prediction, a classification, a confidence metric, an answer, a recognized pattern, a recommendation, an evaluation, or the like. Workload data for a specific machine learning ensemble 222, in one embodiment, has substantially the same format as the initialization data used to train and/or evaluate the machine learning ensemble 222. For example, initialization data and/or workload data may include one or more features. As used herein, a feature may comprise a column, category, data type, attribute, characteristic, label, or other grouping of data. For example, in embodiments where initialization data and/or workload data that is organized in a table format, a column of data may be a feature. Initialization data and/or workload data may include one or more instances of the associated features. In a table format, where columns of data are associated with features, a row of data is an instance.

As described below with regard to FIG. 4, in one embodiment, the data receiver module 300 may maintain client data, such as initialization data and/or workload data, in a data repository 406, where the function generator module 301, the machine learning compiler module 302, or the like may access the data. In certain embodiments, as described below, the function generator module 301 and/or the machine learning compiler module 302 may divide initialization data into subsets, using certain subsets of data as training data for generating and training learned functions and using certain subsets of data as test data for evaluating generated learned functions.

The function generator module 301, in certain embodiments, is configured to generate a plurality of learned functions based on training data from the data receiver module 300. A learned function, as used herein, comprises a computer readable code that accepts an input and provides a result. A learned function may comprise a compiled code, a script, text, a data structure, a file, a function, or the like. In certain embodiments, a learned function may accept instances of one or more features as input, and provide a result, such as a classification, a confidence metric, an inferred function, a regression function, an answer, a recognized pattern, a recommendation, an evaluation, or the like. In another embodiment, certain learned functions may accept instances of one or more features as input, and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 301 may generate learned functions from multiple different machine learning classes, models, or algorithms. For example, the function generator module 301 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Naïve Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 301 generates learned functions pseudo-randomly, without regard to the effectiveness of the generated learned functions, without prior knowledge regarding the suitability of the generated learned functions for the associated training data, or the like. For example, the function generator module 301 may generate a total number of learned functions that is large enough that at least a subset of the generated learned functions are statistically likely to be effective. As used herein, pseudo-randomly indicates that the function generator module 301 is configured to generate learned functions in an automated manner, without input or selection of learned functions, machine learning classes or models for the learned functions, or the like by a Data Scientist, expert, or other user.

The function generator module 301, in certain embodiments, generates as many learned functions as possible for a requested machine learning ensemble 222, given one or more parameters or limitations. A client 104 may provide a parameter or limitation for learned function generation as part of a new ensemble request or the like to an interface module 402 as described below with regard to FIG. 4, such as an amount of time; an allocation of system resources such as a number of processor nodes or cores, or an amount of volatile memory; a number of learned functions; runtime constraints on the requested ensemble 222 such as an indicator of whether or not the requested ensemble 222 should provide results in real-time; and/or another parameter or limitation from a client 104.

The number of learned functions that the function generator module 301 may generate for building a machine learning ensemble 222 may also be limited by capabilities of the system 100, such as a number of available processors or processor cores, a current load on the system 100, a price of remote processing resources over the data network 110; or other hardware capabilities of the system 100 available to the function generator module 301. The function generator module 301 may balance the hardware capabilities of the system 100 with an amount of time available for generating learned functions and building a machine learning ensemble 222 to determine how many learned functions to generate for the machine learning ensemble 222.

In one embodiment, the function generator module 301 may generate at least 50 learned functions for a machine learning ensemble 222. In a further embodiment, the function generator module 301 may generate hundreds, thousands, or millions of learned functions, or more, for a machine learning ensemble 222. By generating an unusually large number of learned functions from different classes without regard to the suitability or effectiveness of the generated learned functions for training data, in certain embodiments, the function generator module 301 ensures that at least a subset of the generated learned functions, either individually or in combination, are useful, suitable, and/or effective for the training data without careful curation and fine tuning by a Data Scientist or other expert.

Similarly, by generating learned functions from different machine learning classes without regard to the effectiveness or the suitability of the different machine learning classes for training data, the function generator module 301, in certain embodiments, may generate learned functions that are useful, suitable, and/or effective for the training data due to the sheer amount of learned functions generated from the different machine learning classes. This brute force, trial-and-error approach to generating learned functions, in certain embodiments, eliminates or minimizes the role of a Data Scientist or other expert in generation of a machine learning ensemble 222.

The function generator module 301, in certain embodiments, divides initialization data from the data receiver module 300 into various subsets of training data, and may use different training data subsets, different combinations of multiple training data subsets, or the like to generate different learned functions. The function generator module 301 may divide the initialization data into training data subsets by feature, by instance, or both. For example, a training data subset may comprise a subset of features of initialization data, a subset of features of initialization data, a subset of both features and instances of initialization data, or the like. Varying the features and/or instances used to train different learned functions, in certain embodiments, may further increase the likelihood that at least a subset of the generated learned functions are useful, suitable, and/or effective. In a further embodiment, the function generator module 301 ensures that the available initialization data is not used in its entirety as training data for any one learned function, so that at least a portion of the initialization data is available for each learned function as test data, which is described in greater detail below with regard to the function evaluator module 312 of FIG. 3.

In one embodiment, the function generator module 301 may also generate additional learned functions in cooperation with the machine learning compiler module 302. The function generator module 301 may provide a learned function request interface, allowing the machine learning compiler module 302 or another module, a client 104, or the like to send a learned function request to the function generator module 301 requesting that the function generator module 301 generate one or more additional learned functions. In one embodiment, a learned function request may include one or more attributes for the requested one or more learned functions. For example, a learned function request, in various embodiments, may include a machine learning class for a requested learned function, one or more features for a requested learned function, instances from initialization data to use as training data for a requested learned function, runtime constraints on a requested learned function, or the like. In another embodiment, a learned function request may identify initialization data, training data, or the like for one or more requested learned functions and the function generator module 301 may generate the one or more learned functions pseudo-randomly, as described above, based on the identified data.

The machine learning compiler module 302, in one embodiment, is configured to form a machine learning ensemble 222 using learned functions from the function generator module 301. As used herein, a machine learning ensemble 222 comprises an organized set of a plurality of learned functions. Providing a classification, a confidence metric, an inferred function, a regression function, an answer, or another result using a machine learning ensemble 222, in certain embodiments, may be more accurate than using a single learned function.

The machine learning compiler module 302 is described in greater detail below with regard to FIG. 3. The machine learning compiler module 302, in certain embodiments, may combine and/or extend learned functions to form new learned functions, may request additional learned functions from the function generator module 301, or the like for inclusion in a machine learning ensemble 222. In one embodiment, the machine learning compiler module 302 evaluates learned functions from the function generator module 301 using test data to generate evaluation metadata. The machine learning compiler module 302, in a further embodiment, may evaluate combined learned functions, extended learned functions, combined-extended learned functions, additional learned functions, or the like using test data to generate evaluation metadata.

The machine learning compiler module 302, in certain embodiments, maintains evaluation metadata in a metadata library 314, as described below with regard to FIGS. 3 and 4. The machine learning compiler module 302 may select learned functions (e.g. learned functions from the function generator module 301, combined learned functions, extended learned functions, learned functions from different machine learning classes, and/or combined-extended learned functions) for inclusion in a machine learning ensemble 222 based on the evaluation metadata. In a further embodiment, the machine learning compiler module 302 may synthesize the selected learned functions into a final, synthesized function or function set for a machine learning ensemble 222 based on evaluation metadata. The machine learning compiler module 302, in another embodiment, may include synthesized evaluation metadata in a machine learning ensemble 222 for directing data through the machine learning ensemble 222 or the like.

In one embodiment, the feature selector module 304 determines which features of initialization data to use in the machine learning ensemble 222, and in the associated learned functions, and/or which features of the initialization data to exclude from the machine learning ensemble 222, and from the associated learned functions. As described above, initialization data, and the training data and test data derived from the initialization data, may include one or more features. Learned functions and the machine learning ensembles 222 that they form are configured to receive and process instances of one or more features. Certain features may be more predictive than others, and the more features that the machine learning compiler module 302 processes and includes in the generated machine learning ensemble 222, the more processing overhead used by the machine learning compiler module 302, and the more complex the generated machine learning ensemble 222 becomes. Additionally, certain features may not contribute to the effectiveness or accuracy of the results from a machine learning ensemble 222, but may simply add noise to the results.

The feature selector module 304, in one embodiment, cooperates with the function generator module 301 and the machine learning compiler module 302 to evaluate the effectiveness of various features, based on evaluation metadata from the metadata library 314 described below. For example, the function generator module 301 may generate a plurality of learned functions for various combinations of features, and the machine learning compiler module 302 may evaluate the learned functions and generate evaluation metadata. Based on the evaluation metadata, the feature selector module 304 may select a subset of features that are most accurate or effective, and the machine learning compiler module 302 may use learned functions that utilize the selected features to build the machine learning ensemble 222. The feature selector module 304 may select features for use in the machine learning ensemble 222 based on evaluation metadata for learned functions from the function generator module 301, combined learned functions from the combiner module 306, extended learned functions from the extender module 308, combined extended functions, synthesized learned functions from the synthesizer module 310, or the like.

In a further embodiment, the feature selector module 304 may cooperate with the machine learning compiler module 302 to build a plurality of different machine learning ensembles 222 for the same initialization data or training data, each different machine learning ensemble 222 utilizing different features of the initialization data or training data. The machine learning compiler module 302 may evaluate each different machine learning ensemble 222, using the function evaluator module 312 described below, and the feature selector module 304 may select the machine learning ensemble 222 and the associated features which are most accurate or effective based on the evaluation metadata for the different machine learning ensembles 222. In certain embodiments, the machine learning compiler module 302 may generate tens, hundreds, thousands, millions, or more different machine learning ensembles 222 so that the feature selector module 304 may select an optimal set of features (e.g. the most accurate, most effective, or the like) with little or no input from a Data Scientist, expert, or other user in the selection process.

In one embodiment, the machine learning compiler module 302 may generate a machine learning ensemble 222 for each possible combination of features from which the feature selector module 304 may select. In a further embodiment, the machine learning compiler module 302 may begin generating machine learning ensembles 222 with a minimal number of features, and may iteratively increase the number of features used to generate machine learning ensembles 222 until an increase in effectiveness or usefulness of the results of the generated machine learning ensembles 222 fails to satisfy a feature effectiveness threshold. By increasing the number of features until the increases stop being effective, in certain embodiments, the machine learning compiler module 302 may determine a minimum effective set of features for use in a machine learning ensemble 222, so that generation and use of the machine learning ensemble 222 is both effective and efficient. The feature effectiveness threshold may be predetermined or hard coded, may be selected by a client 104 as part of a new ensemble request or the like, may be based on one or more parameters or limitations, or the like.

During the iterative process, in certain embodiments, once the feature selector module 304 determines that a feature is merely introducing noise, the machine learning compiler module 302 excludes the feature from future iterations, and from the machine learning ensemble 222. In one embodiment, a client 104 may identify one or more features as required for the machine learning ensemble 222, in a new ensemble request or the like. The feature selector module 304 may include the required features in the machine learning ensemble 222, and select one or more of the remaining optional features for inclusion in the machine learning ensemble 222 with the required features.

In a further embodiment, based on evaluation metadata from the metadata library 314, the feature selector module 304 determines which features from initialization data and/or training data are adding noise, are not predictive, are the least effective, or the like, and excludes the features from the machine learning ensemble 222. In other embodiments, the feature selector module 304 may determine which features enhance the quality of results, increase effectiveness, or the like, and selects the features for the machine learning ensemble 222.

In one embodiment, the feature selector module 304 causes the machine learning compiler module 302 to repeat generating, combining, extending, and/or evaluating learned functions while iterating through permutations of feature sets. At each iteration, the function evaluator module 312 may determine an overall effectiveness of the learned functions in aggregate for the current iteration's selected combination of features. Once the feature selector module 304 identifies a feature as noise introducing, the feature selector module may exclude the noisy feature and the machine learning compiler module 302 may generate a machine learning ensemble 222 without the excluded feature. In one embodiment, the predictive correlation module 318 determines one or more features, instances of features, or the like that correlate with higher confidence metrics (e.g. that are most effective in predicting results with high confidence). The predictive correlation module 318 may cooperate with, be integrated with, or otherwise work in concert with the feature selector module 304 to determine one or more features, instances of features, or the like that correlate with higher confidence metrics. For example, as the feature selector module 304 causes the machine learning compiler module 302 to generate and evaluate learned functions with different sets of features, the predictive correlation module 318 may determine which features and/or instances of features correlate with higher confidence metrics, are most effective, or the like based on metadata from the metadata library 314.

The predictive correlation module 318, in certain embodiments, is configured to harvest metadata regarding which features correlate to higher confidence metrics, to determine which feature was predictive of which outcome or result, or the like. In one embodiment, the predictive correlation module 318 determines the relationship of a feature's predictive qualities for a specific outcome or result based on each instance of a particular feature. In other embodiments, the predictive correlation module 318 may determine the relationship of a feature's predictive qualities based on a subset of instances of a particular feature. For example, the predictive correlation module 318 may discover a correlation between one or more features and the confidence metric of a predicted result by attempting different combinations of features and subsets of instances within an individual feature's dataset, and measuring an overall impact on predictive quality, accuracy, confidence, or the like. The predictive correlation module 318 may determine predictive features at various granularities, such as per feature, per subset of features, per instance, or the like.

In one embodiment, the predictive correlation module 318 determines one or more features with a greatest contribution to a predicted result or confidence metric as the machine learning compiler module 302 forms the machine learning ensemble 222, based on evaluation metadata from the metadata library 314, or the like. For example, the machine learning compiler module 302 may build one or more synthesized learned functions 324 that are configured to provide one or more features with a greatest contribution as part of a result. In another embodiment, the predictive correlation module 318 may determine one or more features with a greatest contribution to a predicted result or confidence metric dynamically at runtime as the machine learning ensemble 222 determines the predicted result or confidence metric. In such embodiments, the predictive correlation module 318 may be part of, integrated with, or in communication with the machine learning ensemble 222. The predictive correlation module 318 may cooperate with the machine learning ensemble 222, such that the machine learning ensemble 222 provides a listing of one or more features that provided a greatest contribution to a predicted result or confidence metric as part of a response to an analysis request.

In determining features that are predictive, or that have a greatest contribution to a predicted result or confidence metric, the predictive correlation module 318 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently, but has a very high impact on the predicted result or confidence metric (e.g. provides at or near 100% confidence or the like). While the predictive correlation module 318 is described herein as determining features that are predictive or that have a greatest contribution, in other embodiments, the predictive correlation module 318 may determine one or more specific instances of a feature that are predictive, have a greatest contribution to a predicted result or confidence metric, or the like.

In the depicted embodiment, the machine learning compiler module 302 includes a combiner module 306. The combiner module 306 combines learned functions, forming sets, strings, groups, trees, or clusters of combined learned functions. In certain embodiments, the combiner module 306 combines learned functions into a prescribed order, and different orders of learned functions may have different inputs, produce different results, or the like. The combiner module 306 may combine learned functions in different combinations. For example, the combiner module 306 may combine certain learned functions horizontally or in parallel, joined at the inputs and at the outputs or the like, and may combine certain learned functions vertically or in series, feeding the output of one learned function into the input of another learned function.

The combiner module 306 may determine which learned functions to combine, how to combine learned functions, or the like based on evaluation metadata for the learned functions from the metadata library 314, generated based on an evaluation of the learned functions using test data, as described below with regard to the function evaluator module 312. The combiner module 306 may request additional learned functions from the function generator module 301, for combining with other learned functions. For example, the combiner module 306 may request a new learned function with a particular input and/or output to combine with an existing learned function, or the like.

While the combining of learned functions may be informed by evaluation metadata for the learned functions, in certain embodiments, the combiner module 306 combines a large number of learned functions pseudo-randomly, forming a large number of combined functions. For example, the combiner module 306, in one embodiment, may determine each possible combination of generated learned functions, as many combinations of generated learned functions as possible given one or more limitations or constraints, a selected subset of combinations of generated learned functions, or the like, for evaluation by the function evaluator module 312. In certain embodiments, by generating a large number of combined learned functions, the combiner module 306 is statistically likely to form one or more combined learned functions that are useful and/or effective for the training data.

In the depicted embodiment, the machine learning compiler module 302 includes an extender module 308. The extender module 308, in certain embodiments, is configured to add one or more layers to a learned function. For example, the extender module 308 may extend a learned function or combined learned function by adding a probabilistic model layer, such as a Bayesian belief network layer, a Bayes classifier layer, a Boltzman layer, or the like.

Certain classes of learned functions, such as probabilistic models, may be configured to receive either instances of one or more features as input, or the output results of other learned functions, such as a classification and a confidence metric, a recognized pattern, a recommendation, an evaluation, or the like. The extender module 308 may use these types of learned functions to extend other learned functions. The extender module 308 may extend learned functions generated by the function generator module 301 directly, may extend combined learned functions from the combiner module 306, may extend other extended learned functions, may extend synthesized learned functions from the synthesizer module 310, or the like.

In one embodiment, the extender module 308 determines which learned functions to extend, how to extend learned functions, or the like based on evaluation metadata from the metadata library 314. The extender module 308, in certain embodiments, may request one or more additional learned functions from the function generator module 301 and/or one or more additional combined learned functions from the combiner module 306, for the extender module 308 to extend.

While the extending of learned functions may be informed by evaluation metadata for the learned functions, in certain embodiments, the extender module 308 generates a large number of extended learned functions pseudo-randomly. For example, the extender module 308, in one embodiment, may extend each possible learned function and/or combination of learned functions, may extend a selected subset of learned functions, may extend as many learned functions as possible given one or more limitations or constraints, or the like, for evaluation by the function evaluator module 312. In certain embodiments, by generating a large number of extended learned functions, the extender module 308 is statistically likely to form one or more extended learned functions and/or combined extended learned functions that are useful and/or effective for the training data.

In the depicted embodiment, the machine learning compiler module 302 includes a synthesizer module 310. The synthesizer module 310, in certain embodiments, is configured to organize a subset of learned functions into the machine learning ensemble 222, as synthesized learned functions 324. In a further embodiment, the synthesizer module 310 includes evaluation metadata from the metadata library 314 of the function evaluator module 312 in the machine learning ensemble 222 as a synthesized metadata rule set 322, so that the machine learning ensemble 222 includes synthesized learned functions 324 and evaluation metadata, the synthesized metadata rule set 322, for the synthesized learned functions 324.

The learned functions that the synthesizer module 310 synthesizes or organizes into the synthesized learned functions 324 of the machine learning ensemble 222, may include learned functions directly from the function generator module 301, combined learned functions from the combiner module 306, extended learned functions from the extender module 308, combined extended learned functions, or the like. As described below, in one embodiment, the function selector module 316 selects the learned functions for the synthesizer module 310 to include in the machine learning ensemble 222. In certain embodiments, the synthesizer module 310 organizes learned functions by preparing the learned functions and the associated evaluation metadata for processing workload data to reach a result. For example, as described below, the synthesizer module 310 may organize and/or synthesize the synthesized learned functions 324 and the synthesized metadata rule set 322 for the orchestration module 320 to use to direct workload data through the synthesized learned functions 324 to produce a result.

In one embodiment, the function evaluator module 312 evaluates the synthesized learned functions 324 that the synthesizer module 310 organizes, and the synthesizer module 310 synthesizes and/or organizes the synthesized metadata rule set 322 based on evaluation metadata that the function evaluation module 312 generates during the evaluation of the synthesized learned functions 324, from the metadata library 314 or the like.

In the depicted embodiment, the machine learning compiler module 302 includes a function evaluator module 312. The function evaluator module 312 is configured to evaluate learned functions using test data, or the like. The function evaluator module 312 may evaluate learned functions generated by the function generator module 301, learned functions combined by the combiner module 306 described above, learned functions extended by the extender module 308 described above, combined extended learned functions, synthesized learned functions 324 organized into the machine learning ensemble 222 by the synthesizer module 310 described above, or the like.

Test data for a learned function, in certain embodiments, comprises a different subset of the initialization data for the learned function than the function generator module 301 used as training data. The function evaluator module 312, in one embodiment, evaluates a learned function by inputting the test data into the learned function to produce a result, such as a classification, a confidence metric, an inferred function, a regression function, an answer, a recognized pattern, a recommendation, an evaluation, or another result.

Test data, in certain embodiments, comprises a subset of initialization data, with a feature associated with the requested result removed, so that the function evaluator module 312 may compare the result from the learned function to the instances of the removed feature to determine the accuracy and/or effectiveness of the learned function for each test instance. For example, if a client 104 has requested a machine learning ensemble 222 to predict whether a customer will be a repeat customer, and provided historical customer information as initialization data, the function evaluator module 312 may input a test data set comprising one or more features of the initialization data other than whether the customer was a repeat customer into the learned function, and compare the resulting predictions to the initialization data to determine the accuracy and/or effectiveness of the learned function.

The function evaluator module 312, in one embodiment, is configured to maintain evaluation metadata for an evaluated learned function in the metadata library 314. The evaluation metadata, in certain embodiments, comprises log data generated by the function generator module 301 while generating learned functions, the function evaluator module 312 while evaluating learned functions, or the like.

In one embodiment, the evaluation metadata includes indicators of one or more training data sets that the function generator module 301 used to generate a learned function. The evaluation metadata, in another embodiment, includes indicators of one or more test data sets that the function evaluator module 312 used to evaluate a learned function. In a further embodiment, the evaluation metadata includes indicators of one or more decisions made by and/or branches taken by a learned function during an evaluation by the function evaluator module 312. The evaluation metadata, in another embodiment, includes the results determined by a learned function during an evaluation by the function evaluator module 312. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data, and may be represented by a correctness indicator for each evaluated instance, a percentage, a ratio, or the like. Different classes of learned functions, in certain embodiments, may have different types of evaluation metadata.

The metadata library 314, in one embodiment, provides evaluation metadata for learned functions to the feature selector module 304, the predictive correlation module 318, the combiner module 306, the extender module 308, and/or the synthesizer module 310. The metadata library 314 may provide an API, a shared library, one or more function calls, or the like providing access to evaluation metadata. The metadata library 314, in various embodiments, may store or maintain evaluation metadata in a database format, as one or more flat files, as one or more lookup tables, as a sequential log or log file, or as one or more other data structures. In one embodiment, the metadata library 314 may index evaluation metadata by learned function, by feature, by instance, by training data, by test data, by effectiveness, and/or by another category or attribute and may provide query access to the indexed evaluation metadata. The function evaluator module 312 may update the metadata library 314 in response to each evaluation of a learned function, adding evaluation metadata to the metadata library 314 or the like.

The function selector module 316, in certain embodiments, may use evaluation metadata from the metadata library 314 to select learned functions for the combiner module 306 to combine, for the extender module 308 to extend, for the synthesizer module 310 to include in the machine learning ensemble 222, or the like. For example, in one embodiment, the function selector module 316 may select learned functions based on evaluation metrics, learning metrics, effectiveness metrics, convergence metrics, or the like. In another embodiment, the function selector module 316 may select learned functions for the combiner module 306 to combine and/or for the extender module 308 to extend based on features of training data used to generate the learned functions, or the like.

The machine learning ensemble 222, in certain embodiments, provides predictive results for an analysis request by processing workload data of the analysis request using a plurality of learned functions (e.g., the synthesized learned functions 324). As described above, results from the machine learning ensemble 222, in various embodiments, may include a classification, a confidence metric, an inferred function, a regression function, an answer, a recognized pattern, a recommendation, an evaluation, and/or another result. For example, in one embodiment, the machine learning ensemble 222 provides a classification and a confidence metric for each instance of workload data input into the machine learning ensemble 222, or the like. Workload data, in certain embodiments, may be substantially similar to test data, but the missing feature from the initialization data is not known, and is to be solved for by the machine learning ensemble 222. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes or no), a rating on a scale (e.g., 4 on a scale of 1 to 5), or another data type for a feature. A confidence metric, in certain embodiments, may comprise a percentage, a ratio, a rating on a scale, or another indicator of accuracy, effectiveness, and/or confidence.

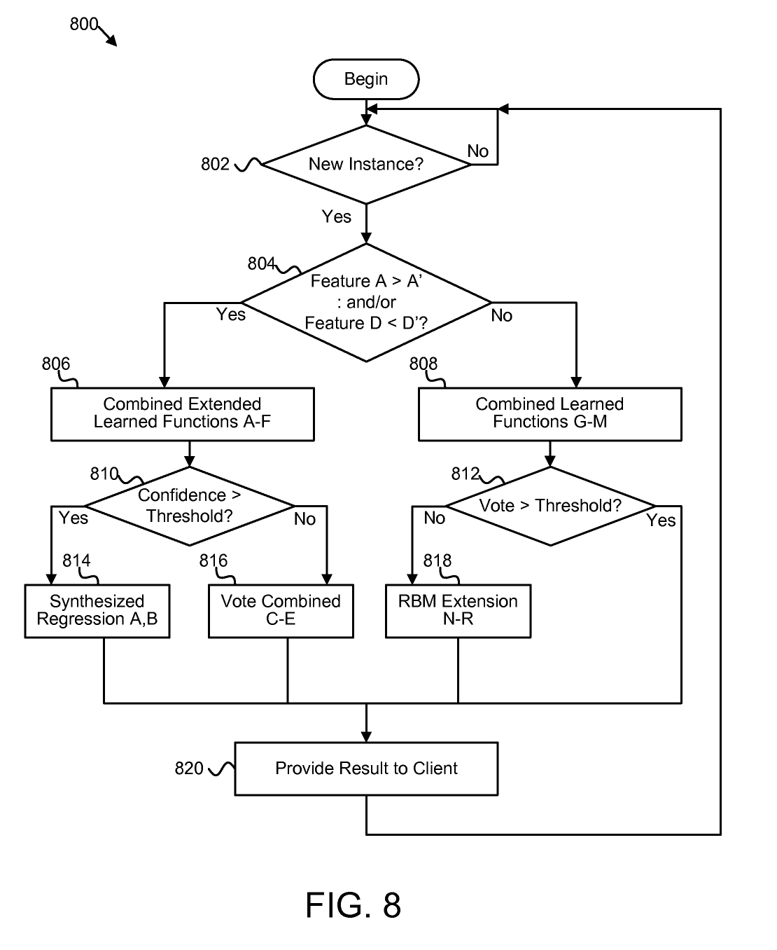

In the depicted embodiment, the machine learning ensemble 222 includes an orchestration module 320. The orchestration module 320, in certain embodiments, is configured to direct workload data through the machine learning ensemble 222 to produce a result, such as a classification, a confidence metric, an inferred function, a regression function, an answer, a recognized pattern, a recommendation, an evaluation, and/or another result. In one embodiment, the orchestration module 320 uses evaluation metadata from the function evaluator module 312 and/or the metadata library 314, such as the synthesized metadata rule set 322, to determine how to direct workload data through the synthesized learned functions 324 of the machine learning ensemble 222. As described below with regard to FIG. 8, in certain embodiments, the synthesized metadata rule set 322 comprises a set of rules or conditions from the evaluation metadata of the metadata library 314 that indicate to the orchestration module 320 which features, instances, or the like should be directed to which synthesized learned function 324.

For example, the evaluation metadata from the metadata library 314 may indicate which learned functions were trained using which features and/or instances, how effective different learned functions were at making predictions based on different features and/or instances, or the like. The synthesizer module 310 may use that evaluation metadata to determine rules for the synthesized metadata rule set 322, indicating which features, which instances, or the like the orchestration module 320 the orchestration module 320 should direct through which learned functions, in which order, or the like. The synthesized metadata rule set 322, in one embodiment, may comprise a decision tree or other data structure comprising rules which the orchestration module 320 may follow to direct workload data through the synthesized learned functions 324 of the machine learning ensemble 222.

FIG. 4 depicts one embodiment of a system 400 for an ensemble factory. The system 400, in the depicted embodiment, includes several clients 404 in communication with an interface module 402 either locally or over a data network 110. The ensemble factory module 212 of FIG. 4 is substantially similar to the ensemble factory module 212 of FIG. 3, but further includes an interface module 402 and a data repository 406.

The interface module 402, in certain embodiments, is configured to receive requests from clients 404, to provide results to a client 404, or the like. The learned function module 202, for example, may act as a client 404, requesting a machine learning ensemble 222 from the interface module 402 for use with data from the activity monitor module 202 or the like. The interface module 402 may provide a machine learning interface to clients 404, such as an API, a shared library, a hardware command interface, or the like, over which clients 404 may make requests and receive results. The interface module 402 may support new ensemble requests from clients 404, allowing clients to request generation of a new machine learning ensemble 222 from the ensemble factory module 212 or the like. As described above, a new ensemble request may include initialization data; one or more ensemble parameters; a feature, query, question or the like for which a client 404 would like a machine learning ensemble 222 to predict a result; or the like. The interface module 402 may support analysis requests for a result from a machine learning ensemble 222. As described above, an analysis request may include workload data; a feature, query, question or the like; a machine learning ensemble 222; or may include other analysis parameters.

In certain embodiments, the ensemble factory module 212 may maintain a library of generated machine learning ensembles 222, from which clients 404 may request results. In such embodiments, the interface module 402 may return a reference, pointer, or other identifier of the requested machine learning ensemble 222 to the requesting client 404, which the client 404 may use in analysis requests. In another embodiment, in response to the ensemble factory module 212 generating a machine learning ensemble 222 to satisfy a new ensemble request, the interface module 402 may return the actual machine learning ensemble 222 to the client 404, for the client 404 to manage, and the client 404 may include the machine learning ensemble 222 in each analysis request.

The interface module 402 may cooperate with the ensemble factory module 212 to service new ensemble requests, may cooperate with the machine learning ensemble 222 to provide a result to an analysis request, or the like. The ensemble factory module 212, in the depicted embodiment, includes the function generator module 301, the feature selector module 304, the predictive correlation module 318, and the machine learning compiler module 302, as described above. The ensemble factory module 212, in the depicted embodiment, also includes a data repository 406,

The data repository 406, in one embodiment, stores initialization data, so that the function generator module 301, the feature selector module 304, the predictive correlation module 318, and/or the machine learning compiler module 302 may access the initialization data to generate, combine, extend, evaluate, and/or synthesize learned functions and machine learning ensembles 222. The data repository 406 may provide initialization data indexed by feature, by instance, by training data subset, by test data subset, by new ensemble request, or the like. By maintaining initialization data in a data repository 406, in certain embodiments, the ensemble factory module 212 ensures that the initialization data is accessible throughout the machine learning ensemble 222 building process, for the function generator module 301 to generate learned functions, for the feature selector module 304 to determine which features should be used in the machine learning ensemble 222, for the predictive correlation module 318 to determine which features correlate with the highest confidence metrics, for the combiner module 306 to combine learned functions, for the extender module 308 to extend learned functions, for the function evaluator module 312 to evaluate learned functions, for the synthesizer module 310 to synthesize learned functions 324 and/or metadata rule sets 322, or the like.

In the depicted embodiment, the data receiver module 300 is integrated with the interface module 402, to receive initialization data, including training data and test data, from new ensemble requests. The data receiver module 300 stores initialization data in the data repository 406. The function generator module 301 is in communication with the data repository 406, in one embodiment, so that the function generator module 301 may generate learned functions based on training data sets from the data repository 406. The feature selector module 300 and/or the predictive correlation module 318, in certain embodiments, may cooperate with the function generator module 301 and/or the machine learning compiler module 302 to determine which features to use in the machine learning ensemble 222, which features are most predictive or correlate with the highest confidence metrics, or the like.

Within the machine learning compiler module 302, the combiner module 306, the extender module 308, and the synthesizer module 310 are each in communication with both the function generator module 301 and the function evaluator module 312. The function generator module 301, as described above, may generate an initial large amount of learned functions, from different classes or the like, which the function evaluator module 312 evaluates using test data sets from the data repository 406. The combiner module 306 may combine different learned functions from the function generator module 301 to form combined learned functions, which the function evaluator module 312 evaluates using test data from the data repository 406. The combiner module 306 may also request additional learned functions from the function generator module 301.

The extender module 308, in one embodiment, extends learned functions from the function generator module 301 and/or the combiner module 306. The extender module 308 may also request additional learned functions from the function generator module 301. The function evaluator module 312 evaluates the extended learned functions using test data sets from the data repository 406. The synthesizer module 310 organizes, combines, or otherwise synthesizes learned functions from the function generator module 301, the combiner module 306, and/or the extender module 308 into synthesized learned functions 324 for the machine learning ensemble 222. The function evaluator module 312 evaluates the synthesized learned functions 324, and the synthesizer module 310 organizes or synthesizes the evaluation metadata from the metadata library 314 into a synthesized metadata rule set 322 for the synthesized learned functions 324.

As described above, as the function evaluator module 312 evaluates learned functions from the function generator module 301, the combiner module 306, the extender module 308, and/or the synthesizer module 310, the function evaluator module 312 generates evaluation metadata for the learned functions and stores the evaluation metadata in the metadata library 314. In the depicted embodiment, in response to an evaluation by the function evaluator module 312, the function selector module 316 selects one or more learned functions based on evaluation metadata from the metadata library 314. For example, the function selector module 316 may select learned functions for the combiner module 306 to combine, for the extender module 308 to extend, for the synthesizer module 310 to synthesize, or the like.

FIG. 5 depicts one embodiment 500 of learned functions 502, 504, 506 for a machine learning ensemble 222. The learned functions 502, 504, 506 are presented by way of example, and in other embodiments, other types and combinations of learned functions may be used, as described above. Further, in other embodiments, the machine learning ensemble 222 may include an orchestration module 320, a synthesized metadata rule set 322, or the like. In one embodiment, the function generator module 301 generates the learned functions 502. The learned functions 502, in the depicted embodiment, include various collections of selected learned functions 502 from different classes including a collection of decision trees 502a, configured to receive or process a subset A-F of the feature set of the machine learning ensemble 222, a collection of support vector machines (“SVMs”) 502b with certain kernels and with an input space configured with particular subsets of the feature set G-L, and a selected group of regression models 502c, here depicted as a suite of single layer (“SL”) neural nets trained on certain feature sets K-N.

The example combined learned functions 504, combined by the combiner module 306 or the like, include various instances of forests of decision trees 504a configured to receive or process features N-S, a collection of combined trees with support vector machine decision nodes 504b with specific kernels, their parameters and the features used to define the input space of features T-U, as well as combined functions 504c in the form of trees with a regression decision at the root and linear, tree node decisions at the leaves, configured to receive or process features L-R.

Component class extended learned functions 506, extended by the extender module 308 or the like, include a set of extended functions such as a forest of trees 506a with tree decisions at the roots and various margin classifiers along the branches, which have been extended with a layer of Boltzman type Bayesian probabilistic classifiers. Extended learned function 506b includes a tree with various regression decisions at the roots, a combination of standard tree 504b and regression decision tree 504c and the branches are extended by a Bayes classifier layer trained with a particular training set exclusive of those used to train the nodes.

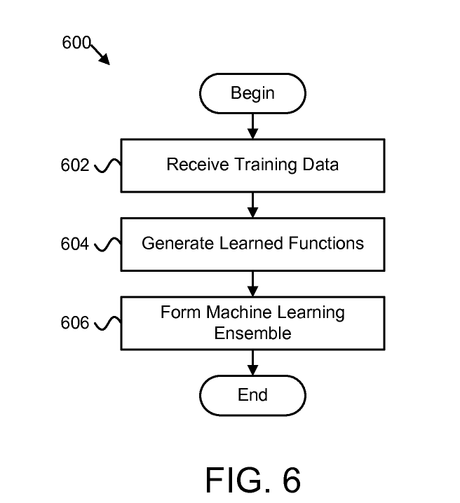

FIG. 6 depicts one embodiment of a method 600 for an ensemble factory. The method 600 begins, and the data receiver module 300 receives 602 training data. The function generator module 301 generates 604 a plurality of learned functions from multiple classes based on the received 602 training data. The machine learning compiler module 302 forms 606 a machine learning ensemble comprising a subset of learned functions from at least two classes, and the method 600 ends.

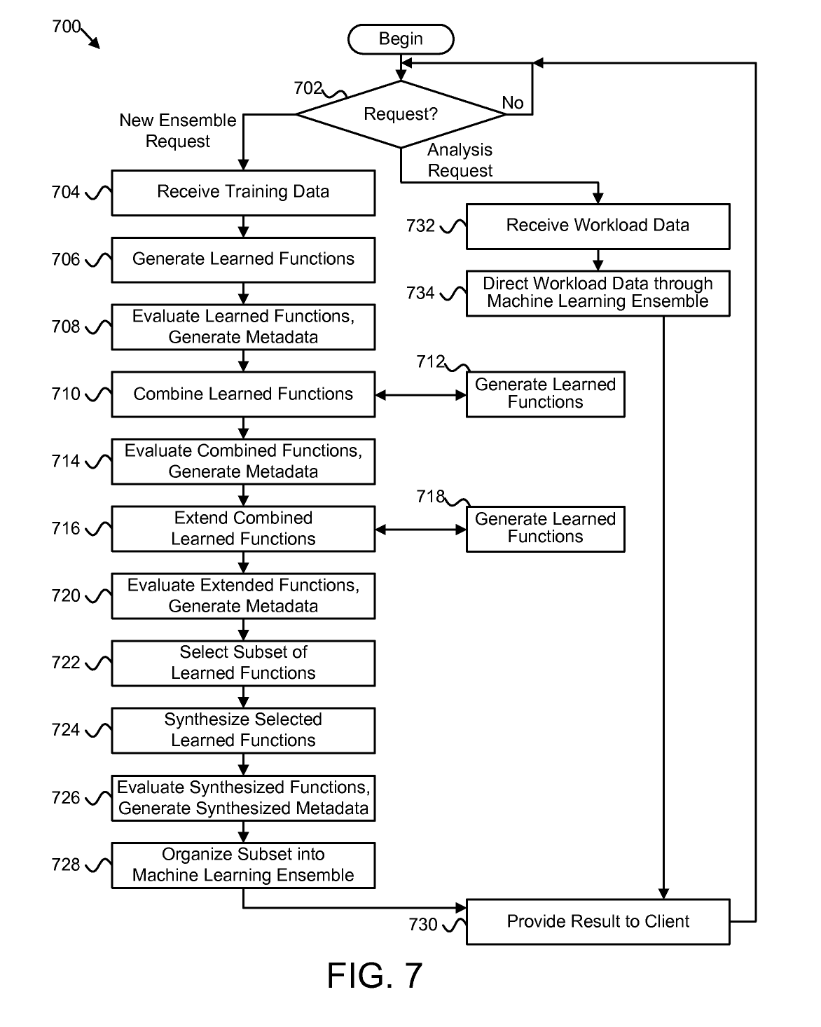

FIG. 7 depicts another embodiment of a method 700 for an ensemble factory. The method 700 begins, and the interface module 402 monitors 702 requests until the interface module 402 receives 702 an analytics request from a client 404 or the like.

If the interface module 402 receives 702 a new ensemble request, the data receiver module 300 receives 704 training data for the new ensemble, as initialization data or the like. The function generator module 301 generates 706 a plurality of learned functions based on the received 704 training data, from different machine learning classes. The function evaluator module 312 evaluates 708 the plurality of generated 706 learned functions to generate evaluation metadata. The combiner module 306 combines 710 learned functions based on the metadata from the evaluation 708. The combiner module 306 may request that the function generator module 301 generate 712 additional learned functions for the combiner module 306 to combine.

The function evaluator module 312 evaluates 714 the combined 710 learned functions and generates additional evaluation metadata. The extender module 308 extends 716 one or more learned functions by adding one or more layers to the one or more learned functions, such as a probabilistic model layer or the like. In certain embodiments, the extender module 308 extends 716 combined 710 learned functions based on the evaluation 712 of the combined learned functions. The extender module 308 may request that the function generator module 301 generate 718 additional learned functions for the extender module 308 to extend. The function evaluator module 312 evaluates 720 the extended 716 learned functions. The function selector module 316 selects 722 at least two learned functions, such as the generated 706 learned functions, the combined 710 learned functions, the extended 716 learned functions, or the like, based on evaluation metadata from one or more of the evaluations 708, 714, 720.

The synthesizer module 310 synthesizes 724 the selected 722 learned functions into synthesized learned functions 324. The function evaluator module 312 evaluates 726 the synthesized learned functions 324 to generate a synthesized metadata rule set 322. The synthesizer module 310 organizes 728 the synthesized 724 learned functions 324 and the synthesized metadata rule set 322 into a machine learning ensemble 222. The interface module 402 provides 730 a result to the requesting client 404, such as the machine learning ensemble 222, a reference to the machine learning ensemble 222, an acknowledgment, or the like, and the interface module 402 continues to monitor 702 requests.

If the interface module 402 receives 702 an analysis request, the data receiver module 300 receives 732 workload data associated with the analysis request. The orchestration module 320 directs 734 the workload data through a machine learning ensemble 222 associated with the received 702 analysis request to produce a result, such as a classification, a confidence metric, an inferred function, a regression function, an answer, a recognized pattern, a recommendation, an evaluation, and/or another result. The interface module 402 provides 730 the produced result to the requesting client 404, and the interface module 402 continues to monitor 702 requests.

FIG. 8 depicts one embodiment of a method 800 for directing data through a machine learning ensemble. The specific synthesized metadata rule set 322 of the depicted method 800 is presented by way of example only, and many other rules and rule sets may be used.

A new instance of workload data is presented 802 to the machine learning ensemble 222 through the interface module 402. The data is processed through the data receiver module 300 and configured for the particular analysis request as initiated by a client 404. In this embodiment the orchestration module 320 evaluates a certain set of features associates with the data instance against a set of thresholds contained within the synthesized metadata rule set 322.

A binary decision 804 passes the instance to, in one case, a certain combined and extended function 806 configured for features A-F or in the other case a different, parallel combined function 808 configured to predict against a feature set G-M. In the first case 806, if the output confidence passes 810 a certain threshold as given by the meta-data rule set the instance is passed to a synthesized, extended regression function 814 for final evaluation, else the instance is passed to a combined collection 816 whose output is a weighted voted based processing a certain set of features. In the second case 808 a different combined function 812 with a simple vote output results in the instance being evaluated by a set of base learned functions extended by a Boltzman type extension 818 or, if a prescribed threshold is meet the output of the synthesized function is the simple vote. The interface module 402 provides 820 the result of the orchestration module directing workload data through the machine learning ensemble 222 to a requesting client 404 and the method 800 continues.

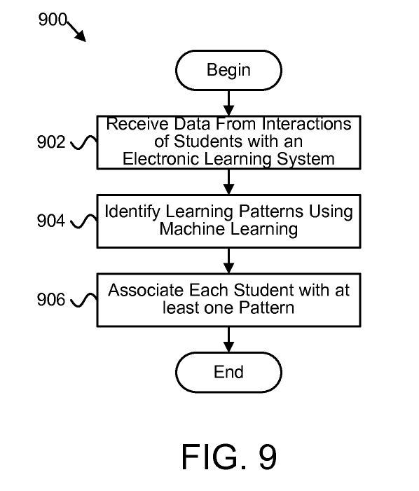

FIG. 9 depicts one embodiment of a method 900 for determining student engagement. The method 900 begins and the activity monitor module 202 receives 902 data collected from interactions of a plurality of students 104 with an electronic learning system. The machine learning module 204 identifies 904 a plurality of archetypal learning patterns in the received 902 data using machine learning. The machine learning module 204 associates 906 each student 104 with at least one of the identified 904 archetypal learning patterns using the machine learning and the method 900 ends.

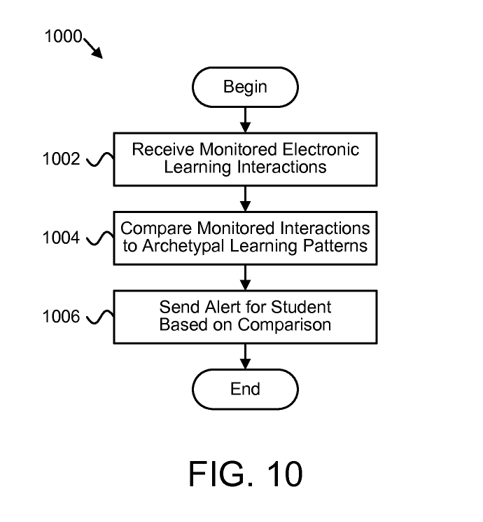

FIG. 10 depicts one embodiment of a method 1000 for determining student engagement. The method 1000 begins and the activity monitor module 202 receives 1002 monitored electronic learning interactions of one or more students 104. The machine learning module 204 compares 1004, using machine learning, the monitored electronic learning interactions to a plurality of archetypal learning patterns. The result module 206 sends 1006 an alert for at least one student 104 of the one or more students 104 based on the machine learning comparison 1004 and the method 1000 ends.

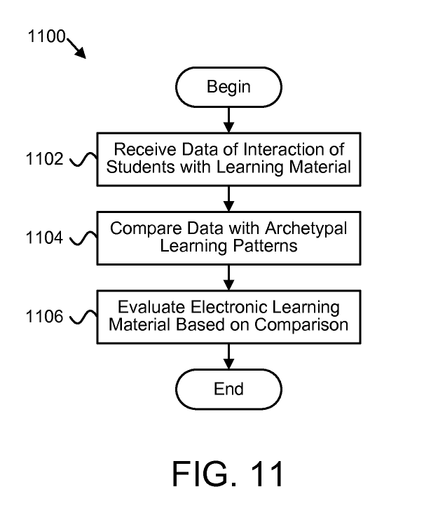

FIG. 11 depicts one embodiment of a method 1100 for determining student engagement. The method 1100 begins and the activity monitor module 202 receives 1102 data associated with interaction of a plurality of students 104 with electronic learning material. The machine learning module 204 compares 1104, using machine learning, the data associated with the interaction with a plurality of archetypal learning patterns. The machine learning module 204 and/or the result module 206 evaluates 1106 the electronic learning material based on the machine learning comparison 1104 and the method 1100 ends.

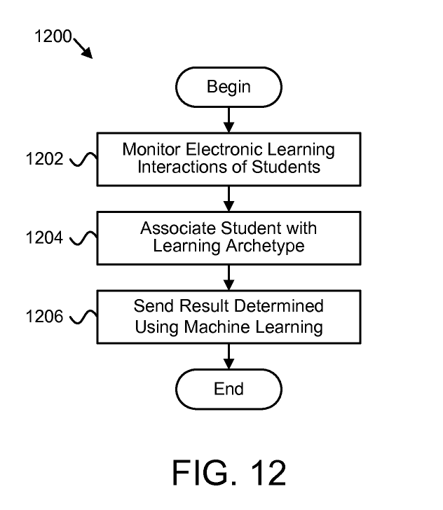

FIG. 12 depicts one embodiment of a method 1200 for determining student engagement. The method 1200 begins and the activity monitor module 202 monitors 1202 electronic learning interactions of a plurality of students 104 with electronic learning material from one or more electronic learning publishers 106. The machine learning module 204 associates 1204 a student 104 with a determined archetypal learning archetype, using machine learning, based on the monitored 1202 electronic learning interactions and on publisher data from the one or more electronic learning publishers 106. The result module 206 sends 1206 a result, such as an alert to one or more learning institutions 108 recommending a learning action to take with regard to one or more of the plurality of students 104, an alert to one or more of the plurality of students 104 recommending a learning action for the one or more students 104 to take, an evaluation of the electronic learning material to the one or more electronic learning publishers 106, or the like and the method 1200 ends.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method for determining student engagement, the method comprising:
receiving data collected from interactions of a plurality of students with an electronic learning system;
identifying a plurality of archetypal learning patterns in the received data using machine learning; and
associating each student with at least one of the identified archetypal learning patterns using the machine learning.

2. The method of claim 1, further comprising modeling each student as a time series path through one or more lessons of the electronic learning system, wherein associating each student with the at least one of the identified archetypal learning patterns comprises correlating the time series path for a particular student with the associated at least one of the identified archetypal learning patterns.

3. The method of claim 1, further comprising sending an alert for at least one student of the plurality of students based on the at least one archetypal learning pattern associated with the at least one student.

4. The method of claim 1, wherein the plurality of archetypal learning patterns are based at least partially on known learning outcomes for a set of students.

5. The method of claim 1, wherein the received data comprises monitored mouse movement of the plurality of students using the electronic learning system.

6. The method of claim 1, wherein the received data comprises an amount of time the plurality of students remain on areas of a presented page of the electronic learning system.

7. The method of claim 1, wherein the received data comprises text selected by the plurality of students from material of the electronic learning system.

8. The method of claim 1, wherein the plurality of archetypal learning patterns comprises:
one or more macro archetypal learning patterns associated with a student's overall success relative to the electronic learning system;
one or more course archetypal learning patterns associated with a single instructional course of the electronic learning system; and
one or more micro archetypal learning patterns associated with a particular lesson of the electronic learning system.

9. The method of claim 1, wherein the machine learning comprises a machine learning ensemble comprising a plurality of learned functions from multiple classes, the plurality of learned functions selected from a larger plurality of generated learned functions.

10. The method of claim 1, wherein the received data is collected using a browser extension installed in internet browsers for each of the plurality of students.

11. The method of claim 1, wherein the received data is collected using a proxy server disposed between the plurality of students and the electronic learning system.

12. The method of claim 1, wherein the received data is collected using executable code embedded in pages sent to the plurality of students by the electronic learning system.

13. An apparatus for determining student engagement, the apparatus comprising:
an activity monitor module configured to receive monitored electronic learning interactions of one or more students;
a machine learning module configured to compare, using machine learning, the monitored electronic learning interactions to a plurality of archetypal learning patterns; and
a result module configured to send an alert for at least one student of the one or more students based on the machine learning comparison.

14. The apparatus of claim 13, wherein the result module is configured to send the alert to an authority associated with the at least one student, the alert recommending a learning action to take with regard to the at least one student, the machine learning module configured to determine the recommended learning action using machine learning.

15. The apparatus of claim 13, wherein the result module is configured to send the alert to the at least one student, the alert recommending a learning action for the student to take, the machine learning module configured to determine the recommended learning action using machine learning.

16. The apparatus of claim 15, wherein the alert comprises a real-time notification presented to the at least one student during the electronic learning interactions of the at least one student.

17. The apparatus of claim 13, further comprising an ensemble factory module configured to form the machine learning, the machine learning comprising a machine learning ensemble comprising a plurality of learned functions from multiple classes, the ensemble factory module configured to generate a larger plurality of generated learned functions using training data and to select the plurality of learned functions for the machine learning ensemble based on an evaluation of the larger plurality of learned functions using test data.

18. The apparatus of claim 13, wherein the machine learning comprises a plurality of machine learning ensembles, different machine learning ensembles associated with different archetypal learning patterns.

19. The apparatus of claim 13, wherein the monitored electronic learning interactions comprise one or more of monitored mouse movement of the one or more students, an amount of time the one or more students remain on a presented electronic learning page, and text selected by the one or more students from electronic learning material.

20. The apparatus of claim 13, wherein the activity module is configured to receive the monitored electronic learning interactions from one or more of a browser extension installed in internet browsers for each of the one or more students, a proxy server disposed between the one or more students and an electronic learning system providing the electronic learning interactions, and executable code embedded in pages with which one or more students are interacting.

21. The apparatus of claim 13, wherein the plurality of archetypal learning patterns comprise one or more of a macro archetypal learning pattern associated with an overall result of a student's electronic learning interactions, a course archetypal learning pattern associated with a single electronic course, and a micro archetypal learning pattern associated with a particular electronic lesson.

22. A computer program product comprising a computer readable storage medium storing computer usable program code executable to perform operations for determining student engagement, the operations comprising:
receiving data associated with interaction of a plurality of students with electronic learning material;
comparing, using machine learning, the data associated with the interaction with a plurality of archetypal learning patterns; and
evaluating the electronic learning material based on the machine learning comparison.

23. The computer program product of claim 22, the operations further comprising recommending a modification to the electronic learning material based on the machine learning comparison.

24. A system for determining student engagement, the system comprising:
a student engagement module configured to be in communication with a plurality of students, one or more electronic learning publishers, and one or more learning institutions, the student engagement module comprising,
an activity monitor module configured to monitor electronic learning interactions of the plurality of students with electronic learning material; and
a machine learning module configured to associate a student with a determined learning archetype, using machine learning, based on the monitored electronic learning interactions and on publisher data from the one or more electronic learning publishers.

25. The system of claim 24, wherein the student engagement module further comprises a result module configured to send an alert to the one or more learning institutions, the alert recommending a learning action to take with regard to one or more of the plurality of students, the machine learning module configured to determine the recommended learning action using machine learning.

26. The system of claim 24, wherein the student engagement module further comprises a result module configured to send an alert to one or more of the plurality of students, the alert recommending a learning action for the one or more students to take, the machine learning module configured to determine the recommended learning action using machine learning.

27. The system of claim 24, wherein the student engagement module further comprises a result module configured to send an evaluation of the electronic learning material to the one or more electronic learning publishers, the machine learning module configured to determine the evaluation using machine learning.
